(19) United States
(12) Patent Application Publication
(10) Pub. No.: US 2008/0011792 A1
(43) Pub. Date: Jan. 17, 2008

(54) PINCH GRIP HANGERS

(75) Inventors: Stanley F. Gouldson, Northport, NY (US); Olaf F. Olk, Hauppauge, NY (US)

Correspondence Address: SCULLY SCOTT MURPHY & PRESSER, PC, 400 GARDEN CITY PLAZA, SUITE 300, GARDEN CITY, NY, 11530, US

(73) Assignee: SPOTLESS PLASTICS PTY. LTD., Moorabbin (AU)

(21) Appl. No.: 11/835,030

(22) Filed: Aug. 7, 2007

Related U.S. Application Data
(63) Continuation of application No. 11/438,840, filed on May 23, 2006, now abandoned.
Application No. 11/438,840 is a continuation of application No. 10/367,231, filed on Feb. 14, 2003, now Pat. No. 7,089,599.
Application No. 10/367,231 is a continuation-in-part of application No. 10/292,128, filed on Nov. 12, 2002, now Pat. No. 6,923,350.
Application No. 10/292,128 is a continuation-in-part of application No. 10/076,790, filed on Feb. 15, 2002, now Pat. No. 7,121,439.

(51) Int. Cl. E05B 69/00

(52) U.S. Cl. 223/91; 223/85

(57) ABSTRACT

A pinch grip hanger has a hook and a support bar suspended from said hook. A pinch grip is mounted on the support bar along its length, having two jaws, with the first jaw mounted on said support bar in a fixed location, and the second jaw pivotally mounted to the first jaw. The second jaw has a user engagement portion, and garment engaging portion extending downwardly from the support bar. The user engagement portion enables a user to open the pinch grip for insertion or release of a garment. A multi-stage spring with has a plurality of linear portions is mounted on the first and second jaws, biasing the garment engaging portion of said second jaw into engagement with said first jaw. The multi-stage spring has multiple stages of spring engagement, allowing a substantially constant spring bias throughout the range of motion of said pinch grip, and can engage both the first and second jaws. Alternately or additionally, a spring has a safety lock means to maintain spring engagement with the jaws. The safety lock means can include a hook member on at least one end of the spring. One or both of the jaws can include a retention rib for engaging the safety lock means and retaining the spring.

### CROSS-REFERENCE TO RELATED APPLICATIONS

This application claims priority under 35 U.S.C. § 120 as a continuation of U.S. patent application Ser. No. 11/438,840 (attorney docket 14785YZX), filed May 23, 2006 now pending, which is a continuation of U.S. patent application Ser. No. 10/367,231, filed Feb. 14, 2003 (attorney docket 14785YZ), which is a continuation-in-part of U.S. patent application Ser. No. 10/292,128 (attorney docket 14785Y), filed Nov. 12, 2002, now U.S. Pat. No. 6,923,350, and U.S. patent application Ser. No. 10/076,790 (attorney docket 14785), filed Feb. 15, 2002, now U.S. Pat. No. 7,121,439. The complete disclosures of the foregoing applications are incorporated herein by their reference.

### BACKGROUND OF THE INVENTION

1. Field of Invention

The present invention relates generally to a pinch grip hangers, and more particularly pertains to a pinch grip hanger used for hanging pants and skirts for shipment to retailers and display of the same in a retail environment. The improved hanger has reduced depth, a greater jaw opening, a greater jaw length, and more constant spring force than prior art hangers.

2. Description of Related Art

Consumer taste and fashion have dictated a desire for mass-produced, but well-fitted garments, which are distributed and sold throughout the United States. Large national retailers of clothing generally contract with a plurality of clothing manufacturers to produce uniform standardized clothing, which is essentially identical from batch to batch, even though manufactured by different entities. These manufacturers in turn produce the clothing at their own plants, or in many cases, subcontract the production of the garments to manufacturers based in the Far East, for instance, in Hong Kong, Taiwan, Singapore and South Korea.

In the retail clothing industry clothing is typically suspended from hangers at the point of purchase. Such hangers are often inexpensive ship-on types and under prevailing garment-on-hanger programs, the garment is shipped from the manufacturer to the retailer while suspended from a hanger. Traditional garment-on-hanger pant and skirt hangers used spring clips that were manually pushed into a locking position to secure the pants or skirts to the hanger. In these hangers, a steel retaining clip was manually clamped over a clam shell garment grip to secure the garment. Use of the hangers in this device required a manual operation to slide the steel clip over the clam shell to close the retention clip on the garment.

However, these hangers were not popular as the physical force needed to close a hanger on a thick waist band could result in increased time and labor costs to load the hanger and complaints of inadvertently broken finger nails were common. For these reasons, pinch grip hangers have become popular in recent years. However, pinch grip hangers generally have greater depth than clip hangers, resulting in fewer garments per rod or per loop when shipping the garments, and a tendency to inadvertently drop the garments when subjected to unexpected shipping loads, as adjacent hangers impact one another and open one or more of the pinch grips. Inadvertent opening of the pinch grips can also occur in a retail store environment, as customers push the garments to one side to better view a garment of interest. Moreover, the length of the pinch grip was not sufficient to grip the waistband of certain garments, so that on impact, the grip would engage the waistband of a garment, causing the garment to easily slip out of the pinch grip hanger. Various guards have been proposed in the prior art to prevent the inadvertent opening of the pinch grips, but these guards also contribute to increased depth for the product.

U.S. Pat. Nos. 4,446,996 and 4,826,056 are typical of early pinch grip hangers intended for mass merchandise market that used open and unprotected pinch grips. Frequently, these pinch grips would open and drop the garment to the floor if the pinch grips were pressed together, as might happen as a result of over crowding a display rod with too many garments, or even as a result of a customer pushing garments aside to better view a single garment of interest.

U.S. Pat. No. 4,194,274 and 5,082,153 are typical of the clamping hangers referred to above, which used a steel spring to secure the jaws of a clam shell clip together. These hangers, while relatively secure in clamping the garment, required significant physical force to close the clam shell clip of the hanger on a thick waist band. This could result in increased time and labor costs to load the hanger and complaints of inadvertently broken finger nails from retail store personnel were common, with occasional repetitive stress injury complaints from factory workers who were loading thousands of garments a day into hangers of this style.

U.S. Pat. No. 3,946,915, illustrates a prior art hanger with the fixed jaw of a pinch grip hanger offset to the rear of the hanger support bar, and a guard member extending outwardly to protect the moveable jaw when the hangers are pressed together. The design of the pinch grip utilized in this device results in a relatively thick hanger with a modest jaw opening.

U.S. Pat. Nos. 5,400,932, 6,019,261 and 6,021,933 are typical of more recent hanger designs that incorporate a guard to prevent the inadvertent opening of pinch grips during shipment. In these designs, the pinch grip with a fixed and a moveable jaw is used, with the fixed jaw integrally molded with the hanger support bar. One or more guard members then extend outwardly from the support bar to protect the moveable jaw from inadvertent actuation. Wile these designs achieve their intended effect, they are relatively thick, reducing the number of hangers that can be shipped on any given support bar. Further, as a result of the pinch grip design utilized, the maximum opening of the pinch grip is limited.

U.S. Pat. No. 4,009,807 is a prior art pinch grip hanger having the pinch grip offset from the center line of the support bar of the hanger. However, in this design, pressing two adjacent hangers together would result in opening the pinch grip, and release of the garment.

U.S. Pat. Nos. 5,516,014 and 5,785,216 disclose the use of a thermoplastic rubber, sold under the name Kraton, by Shell Oil Company. The thermoplastic rubber provides a non-slip grip for the hanger.

The above prior art pinch grip hangers use metal springs with a relatively constant spring rate, which means the pinch grip requires progressively greater force to open as the jaws are opened, i.e., the further the jaws are opened, the greater the bias loading exerted by the spring. This makes it difficult to fully open the jaws of some of these hangers when it is necessary to insert a relatively thick waistband.

These prior art pinch grip hangers are loaded manually, since both pinch grips are normally biased to a closed position by a spring and both must be opened to load a garment into the grips. At the present time this requires an operator to perform four steps. Using one hand the operator must open the first pinch grip and then using the other hand to suspend the garment, one side of the garment is placed in the grip. This process is then repeated for the other pinch grip. With the second pinch grip the operator must also simultaneously tension the garment between the clips, and since both hands are already occupied, the tensioning step may require additional manual movements. At a minimum, four manual steps or movements are required for each garment that is loaded, resulting in relatively high labor costs for loading the garments.

These prior art hangers are difficult to automate as they are not designed to stack load in a magazine, and they frequently have a single pair of projecting high points which causes the hangers to not stack evenly in a magazine. Further, the high points can result in the hanger snagging on the next to be fed hanger in an automated feed mechanism.

### BRIEF SUMMARY OF THE INVENTION

It is an object of the invention to provide an inexpensive secure and protected pinch grip hanger of reduced width to allow greater density of garments during shipment.

It is another object of the invention to provide a secure and protected pinch grip hanger of reduced width having a relatively wide jaw opening to facilitate insertion of garments.

It is another object of the invention to provide a secure and protected pinch grip hanger of reduced width that has a multi-stage spring to provide a relatively constant bias force as the jaws are opened, thus minimizing the total force necessary to fully open the pinch grip.

It is another object of the invention to provide a secure and protected pinch grip hanger of reduced width having a relatively long grip to facilitate insertion of a waistband of a garment above the gripping members.

It is another object of the invention to provide a secure and protected pinch grip hanger of reduced width that is particularly adapted for magazine feed and the automated loading of garments.

These and other objects of the invention are met in an improved pinch grip hanger having a hook and a support bar suspended from said hook. A pinch grip is mounted on the support bar along its length, having two jaws, with the first jaw mounted on said support bar in a fixed location, and the second jaw pivotally mounted to the first jaw. The second jaw has a user engagement portion, and garment engaging portion extending downwardly from the support bar. The user engagement portion enables a user to open the pinch grip for insertion or release of a garment. A multi-stage spring with has a plurality of linear portions is mounted on the first and second jaws, biasing the garment engaging portion of said second jaw into engagement with said first jaw. The multi-stage spring has multiple stages of spring engagement, allowing a substantially constant spring bias throughout the range of motion of said pinch grip, and can engage both the first and second jaws.

In a further embodiment, one or both of the jaws has a recess, the recess engaging the multi-stage spring between an end portion and a bight portion when the second jaw is pivoted relative to the first, thereby effectively shortening the throw of the multi-stage spring.

In another embodiment, the pinch grip banger includes a hook and a support bar suspended from said hook. A pinch grip is mounted on the support bar along its length, having two jaws, with the first jaw mounted on said support bar in a fixed location, and the second jaw pivotally mounted to the first jaw. The second jaw has a user engagement portion, and garment engaging portion extending downwardly from the support bar. The user engagement portion enables a user to open the pinch grip for insertion or release of a garment. A spring is mounted on the two jaws biasing the garment engaging portion of said second jaw into engagement with the first. The spring has a safety lock means to maintain spring engagement with the jaws. The safety lock means can include a hook member on at least one end of the spring. One or both of the jaws can include a retention rib for engaging the safety lock means and retaining the spring. This embodiment may be combined with the foregoing embodiment, where the spring having the safety lock means is a multi-stage spring.

### BRIEF DESCRIPTION OF THE DRAWINGS

FIG. 1 is a plan view of the improved pinch grip hanger of the present invention illustrating a hanger with an integrally formed plastic hook, adapted to receive a removable size indicia. One of the pinch grips has the spring and moveable pinch grip jaw removed for the purpose of illustrating the device.

FIG. 2 is a plan view of the opposite side of the improved pinch grip hanger of FIG. 1 illustrating a hanger with a wire hook. The hanger is adapted to receive a removable size indicia. One of the pinch grips has the spring and the moveable pinch grip jaw (not visible from this side) removed to provide consistency with the illustration of FIG. 1.

FIG. 3(a) is a diagrammatic and perspective view of the inside of the moveable jaw of the pinch grip of the present invention.

FIG. 3(b) is a diagrammatic and perspective view of the inside of the fixed jaw of the pinch grip of the present invention.

FIG. 3(c) is a diagrammatic and perspective view of the inside of the elongated moveable jaw of the pinch grip of the present invention.

FIG. 3(d) is a diagrammatic and perspective view of the inside of the elongated fixed jaw of the pinch grip of the present invention.

FIG. 4 is a top plan view of a plurality of hangers and garments as they might appear when nested together on a shipping or display rod.

FIG. 5 is an enlarged view of one set of the pinch grips illustrated in FIG. 4.

FIG. 6(a) is a side view of the pinch grip of the present invention, particularly illustrating the relationship of the jaws and the spring when the pinch grip is closed.

FIG. 6(b) is a side view of the pinch grip of the present invention, particularly illustrating the relationship of the jaws and the spring when the pinch grip in normal operation, as for example in gripping a garment.

FIG. 6(c) is a side view of the pinch grip of the present invention, particularly illustrating the relationship of the jaws and the spring when the pinch grip is wide open.

FIG. 6(d) is a side view of the elongated pinch grip of the present invention, particularly illustrating one embodiment of the elongated pinch grip when the pinch grip is closed.

FIG. 6(e) is a side view of the elongated pinch grip of the present invention, particularly illustrating a second embodiment of the elongated pinch grip when the pinch grip is closed.

FIG. 6(f) is a side view of the elongated pinch grip of the present invention, particularly illustrating a third embodiment of the elongated pinch grip when the pinch grip is closed.

FIG. 7 is a side view of a plurality of the improved pinch grip hangers of the present invention illustrating the plurality of hangers in a magazine.

FIG. 8 is a plan view of a pinch grip hanger mechanism particularly adapted to automatically dispense the hangers of the present invention, illustrating a plurality of improved pinch grip hangers in the magazine and a pinch grip hanger extended to a garment loading position.

FIG. 9 is a side elevation view of the hanger mechanism, illustrated in FIG. 8 with pinch grip hangers in the magazine and a pinch grip hanger extended to the garment loading point.

FIG. 10(a) is an end view of the multi-stage spring of the present invention.

FIG. 10(b) is an front view of the multi-stage spring illustrated in FIG. 10a.

FIG. 11 is a cross section of the hanger support bar 105 taken along section line K-K′ in FIG. 1.

FIGS. 12(a) and 12(c) illustrate an end view of a first and second version, respectively, of a first embodiment of a size indicator of the present invention for engaging the first web of the hanger illustrated in FIG. 2.

FIG. 12(b) illustrates a top view of the size indicators of FIGS. 12(a) and 12(c).

FIG. 13(a) illustrates an enlarged view of the first web of FIG. 2.

FIG. 13(b) illustrates the enlarged view of the web of FIG. 13a with a size indicator secured thereon.

FIG. 14(a) illustrates a partial sectional view of the web of FIG. 13 as taken along line 5-5 thereof and additionally having the second version of the size indicator secured thereon.

FIG. 14(b) illustrates the first web and the size indicator of FIG. 14(a) wherein the pivoting latch is being pivoted to release the size indicator therefrom.

### DETAILED DESCRIPTION OF THE INVENTION

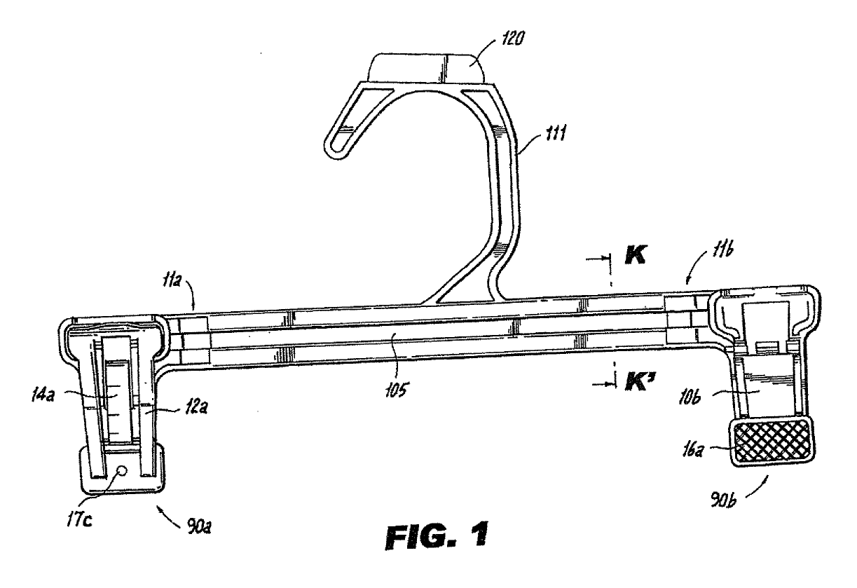

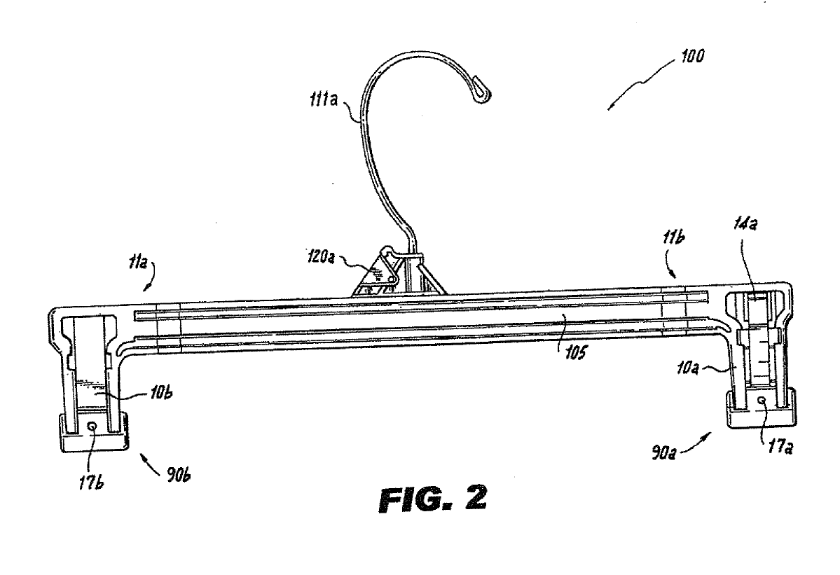

The improved pinch grip hanger 100 of the present invention is illustrated in plan view in FIGS. 1 and 2 with FIG. 1 being a plan view of the front side of the hanger, and FIG. 2 being the reverse side. The improved pinch grip hanger 100 is molded of plastic with a center support bar 105 in an upwardly extended hook member 111. As illustrated in FIG. 1, the hook member 111 is formed of plastic and integrally molded with the support bar 105. As illustrated in FIG. 2, the hanger is fitted with a wire metal hook 111A that is swivel mounted in the central support bar 105 and a manner well known in the art. Hook member 111, as illustrated in FIG. 1 includes an upstanding flange member 120 that is adapted to receive a size indicia for a characteristic of the garment suspended in the hanger. The size indicia may be permanently affixed to the hook 111 as taught by U.S. Pat. No. 5,604,975 or maybe releasably secured as taught by U.S. Pat. No. 5,794,363. Both of these patents are assigned to the assignee of the present invention, and the disclosures of both patents are incorporated herein by reference thereto.

As illustrated in FIG. 2, the present invention may also be fitted with at pivoting flange 120A to receive a side sizer in the matter taught in U.S. Pat. No. 6,260,745, also assigned to the assignee of the present invention. The disclosure of this patent is also incorporated herein by reference thereto.

As illustrated in FIG. 1, the pinch grip hanger includes a first 90a and second 90b pinch grip positioned on either end of the support bar 105. In FIGS. 1 and 2, the moveable pinch grip jaw and spring, to be described later, have been removed from pinch grip 90b for the purpose of illustrating the invention.

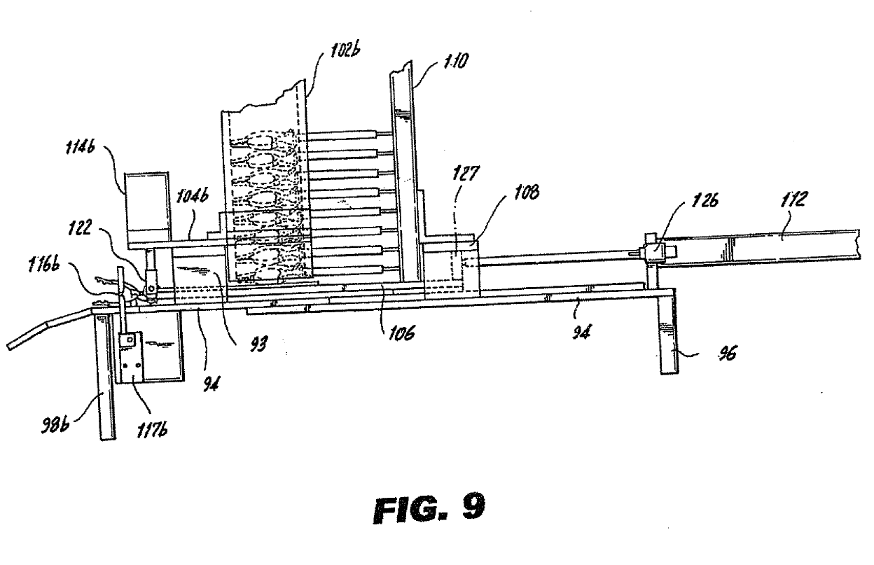

The central support bar 105 is formed of a square M-shaped cross-section, further illustrated in cross section in FIG. 11 which provides exceptional strength along the vertical axis of the hanger. The cross section of FIG. 11 is taken from section line K-K′ in FIG. 1. Each of the pinch grips 90a and 90b include a first and second pinch grip jaws with the first jaw members 10a and 10b being integrally molded with the support bar 105. As will be hereinafter discussed in greater detail, the fixed jaw members 10A and 10B are offset from the center axis of support bar 105 with an offset mounting portions 11a and 11b that enable the fixed jaws 10a and 10b to be mounted behind the rear plane of the central support bar 105. The second jaw members 12a and 12b (12b is omitted in FIG. 1) are pivotally secured to the first jaw members at a pivot mounting, by a spring member 14, as will be hereinafter discussed in detail. It should be noted that spring member 14b is omitted in FIGS. 1 and FIG. 2.

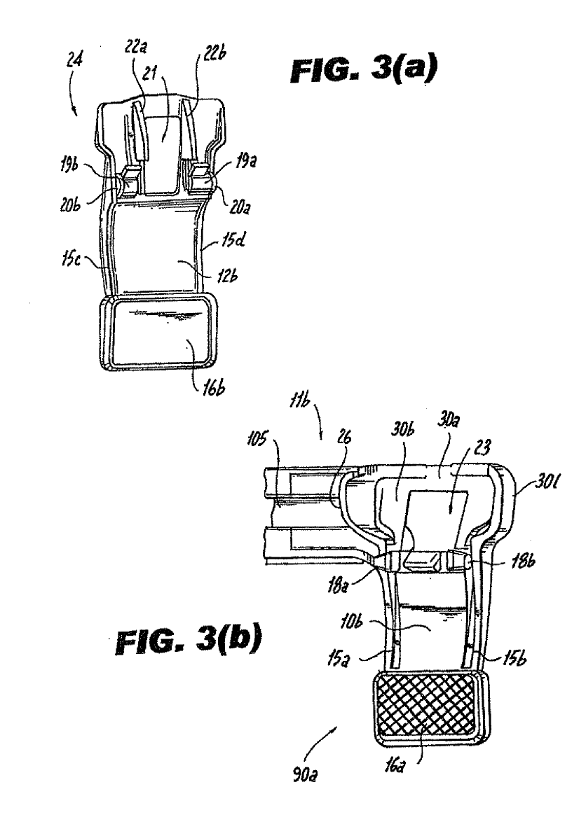

The construction of a typical pinch grip is more fully illustrated in FIGS. 3a-3d. FIG. 3b is a perspective view of the first fixed jaw 10b and FIG. 3a is a perspective view of the second movable jaw 12b, which jaws together form the single pinch grip 90b. FIG. 3c is a perspective view of the elongated first fixed jaw 10b and FIG. 3d is a perspective view of the second movable jaw 12b, where jaws 10b, 12b, together, form the single elongated pinch grip 90b. Each of the pinch grip jaws define garment engaging areas at 16. In FIGS. 3c and 3d, the garment engaging areas 16 are positioned to engage a garment below the waistband even when the garment has a relatively wide waistband. The moveable second jaw member of FIG. 3a also defines a user engagement portion 24 used to open the pinch grip.

The fixed jaw 10b is formed with an arch with a pair of unshaped molded channels 15a and 15b which strengthen the fixed jaw and provide additional strength to resist deflection in the lateral direction. Likewise, the moveable jaw 12b is formed with a similar pair of molded unshaped channels 15c and 15d for the same purpose.

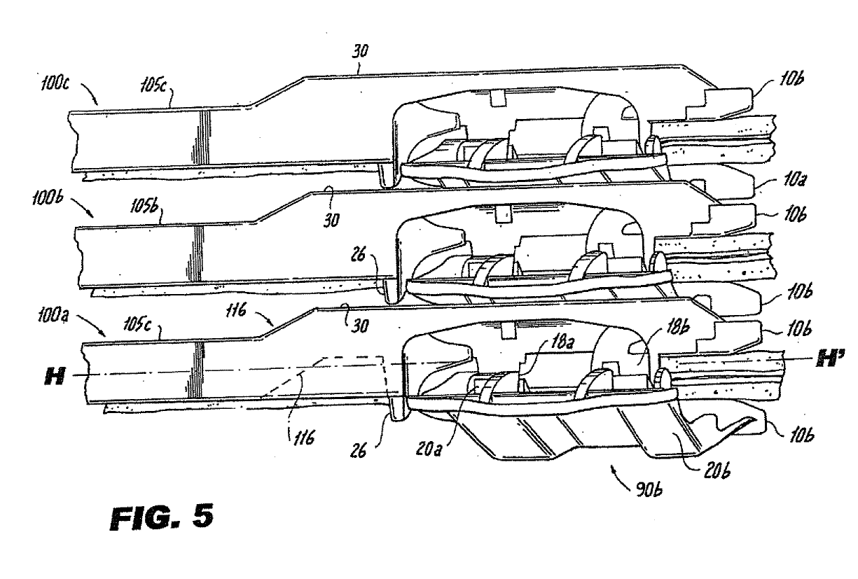

Each of the jaws maybe fitted with a molded non-slip pad 16a as illustrated in FIGS. 3a and 3b, or maybe molded with teeth as more fully illustrated in FIGS. 3c, 3d, 6d -6f, and 7.

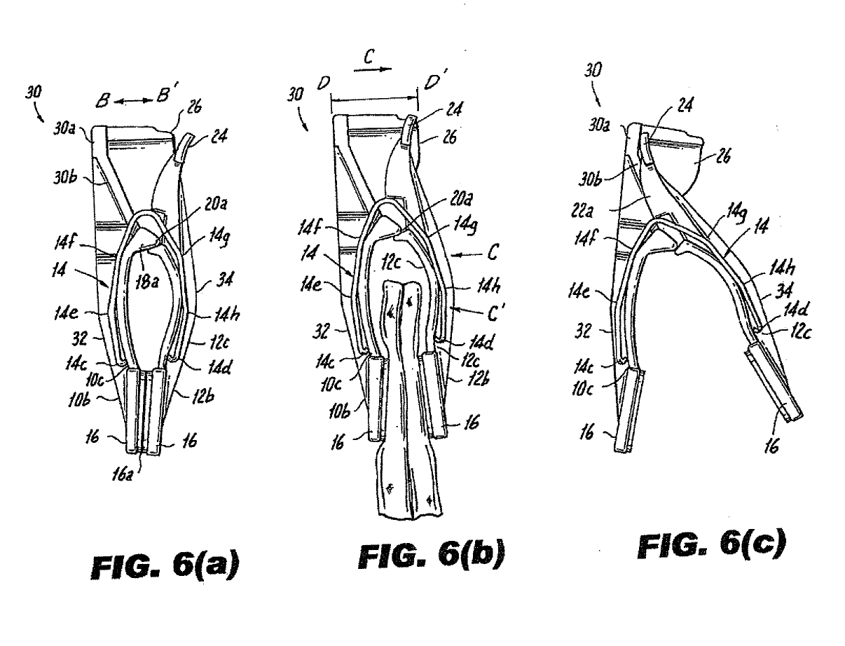

In a first embodiment of the invention, integrally molded teeth are used to engage the garment. As illustrated in FIGS. 3c, 3d, 6d -6f, and 7, the teeth 16c and 16d are integrally molded onto the pinch grips 10b and 12b. Although only one set of teeth is illustrated in FIGS. 3c, 3d, and 6d-6f, a plurality of teeth can exist on either or both the movable jaw 12b or the fixed jaw 10b, as illustrated in FIG. 7.

The teeth 16c, 16d are very effective in retaining garments within the hanger. The increased retention power of the teeth 16c, 16d is derived from channeling the full retention power of the spring member 14a or 14b through the narrow contact area of the teeth 16c, 16d, as compared to alternative gripping surfaces. Accordingly, the teeth 16c, 16d of the elongated pinch grip hangers are particularly suited for rugged and heavy garments such as denim jeans with wide waistbands. Garments made of rugged material have relatively more resiliency than, for example, garments suitable for casual or formal wear. The teeth 16c, 16d can compress garments made from rugged material without there being the concern that the teeth 16c, 16d will leave noticeable impressions at the locations where the teeth 16c, 16d engage the garment.

The teeth 16c on the movable jaw 12b preferably have the same length and width of the teeth 16d on the fixed jaw 10b, although segmenting either or both of the teeth is possible without affecting the operation of the teeth 16c, 16d. The teeth 16c, 16d are designed such that when the pinch grip jaw is closed and not engaging a garment, the outer width of the pinch grip hanger at the teeth location, illustrated as “W” in FIG. 6d, is less than half an inch.

In a preferred embodiment, the teeth are preferably formed so that, when the jaw is closed and not in use, the tip of the bottommost tooth 16d on the movable jaw 12b meets the tip of the bottommost tooth 16d on the fixed jaw 10b, as illustrated in FIG. 6d. In an alternative embodiment, as illustrated in FIG. 6e, the teeth are preferably formed so that, when the jaw is closed and not in use, the tip of the bottommost tooth 16c of the movable jaw 12b is below the tip of the bottommost tooth 16d of the fixed jaw 10b. In another alternative embodiment, as illustrated in FIG. 6f, the teeth are preferably formed so that, when the jaw is closed and not in use, the tip of the bottommost tooth 16c of the movable jaw 12b is above the tip of the bottommost tooth 16c of the fixed jaw 10b. In yet an alternative embodiment, the teeth 16c, 16d are preferably formed as a juxtaposed array, as illustrated in FIG. 7.

As will be more fully described with respect to FIGS. 3c and 3d, the first pinch grip jaw is elongated by a section 200. The elongation section 200 extends the length of the pinch grip by at least the length of a waistband of a garment such as a pair of pants. For example, the typical waistband on a pair of pants has a length that is one inch or less. Accordingly, the length of the elongation section 200 is approximately one inch. Further, the elongation section 200 is essentially linear, as illustrated in FIGS. 6d-6f.

The use of the section 200 allows the pinch grip jaw to grip clothing below a waistband. Gripping clothing below a waistband is beneficial because the waistband is often accompanied with additional bands of fabric, making the waistband area the thickest area of the garment. Gripping the garment below the waistband area thus effectively traps the garment within the pinch grip structure. In comparison, prior art pinch grip hangers gripped the garment on the waistband, and very frequently the friction coefficient of the cloth material was insufficient to hold a heavy garment, with the result that the garment tended to slip out of the grip of the pinch grip hanger in response to an impact on the grip, or sudden movement of the grip. Once the garment began to slip, there was no structure to stop the garment from falling on the floor

A second embodiment of the invention uses non-slip pads rather than teeth to engage the garments. When non-slip pads are used as the garment engaging means, the non-slip pads 16a are formed from a thermoplastic rubber such as Raplan, or the Kraton family of materials manufactured by Shell Oil Company. This material has a high coefficient of friction when engaging a fabric, and is durable enough to maintain pad integrity during repeated clamping cycles. The pads 16a are post molded by injection molding through openings 17a and 17b in the fixed jaw and openings, and openings 17c and 17d in the moveable jaws into corresponding recesses on the garment engagement side, such as recess 16b in FIG. 3a. As illustrated in FIGS. 1 and 3b, the pads are also lightly textured to enhance the non-slip grip on fabric. To facilitate the retention of the pad in the recess, an amount, preferably 15%, of the hanger host plastic material maybe added to the thermoplastic rubber prior to molding the pad. Depending on the host plastic used to mold the hanger, the percentage of host material to be included will vary, and by way of example, a hanger molded of polypropylene will typically have from 10% to 20%, and preferably, approximately 15% polypropylene mixed into the thermoplastic rubber before molding. A higher percentage may be used, but the additional polypropylene begins to degrade the non-slip functionality of the pad. The hanger may also be molded of a blend of K-Resin and SNMA (styrene methyl metbacrylate copolymer), wherein from 1% to 3% host material may be added, since the K-Resin acts as a binding host for the non-slip thermoplastic rubber. This combination will also adhere for most purposes with no host material added.

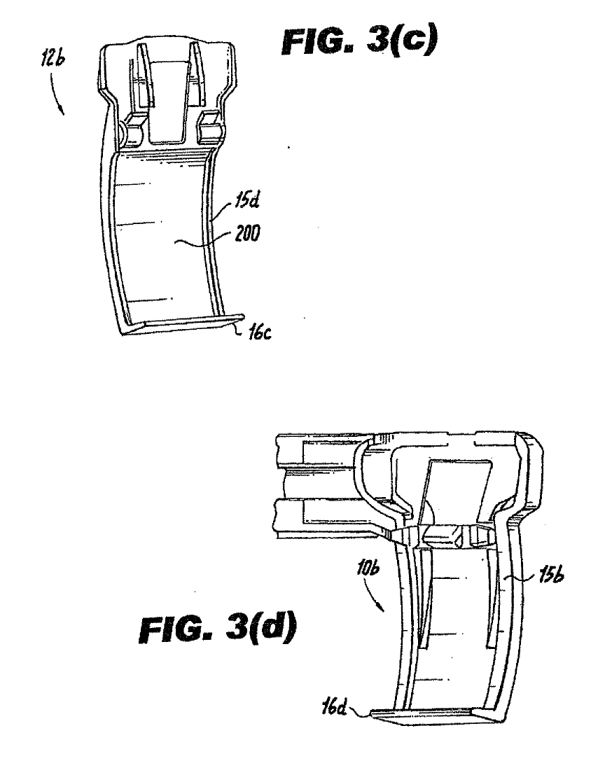

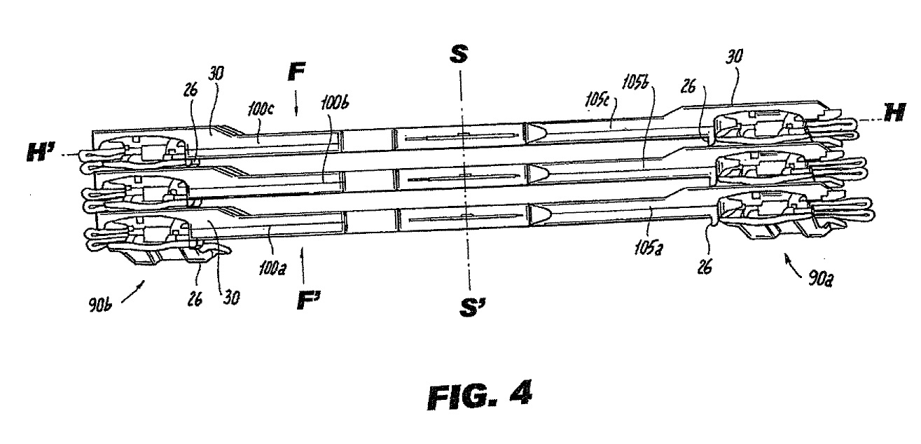

As will be more fully described with respect to FIG. 4 and 5, the first pinch grip jaw 10b is offset from the center axis of the center support bar 105 by means of the offset mounting portion 11B illustrated in FIG. 3b. The use of the offset mounting significantly reduces the overall thickness of the hanger, enabling greater density of hangers in shipment. Extending forwardly through the center axis and the center vertical plane of the hanger are pivot posts 18a and 18b which are received in sockets 19a and 19b formed on the moveable jaw 12b. Lateral movement of the second moveable jaw is constrained by several design features. The first factor is the use of flanges 20a and 20b which bound the outside of sockets 19a and 19b and prevent lateral shifting of the moveable jaw 12b on pivot posts 18a and 18b. Secondly, a fixed post 18c is molded in the fixed jaw, and extends forwardly through an opening 21 defined by the moveable jaw 12b. The moveable jaw also includes a pair of rearwardly projecting flanges 22a and 22b which provide dual functions for the moveable jaw. First, they strengthen and add rigidity to the upper user engagement portion 24 of the moveable jaw to prevent twisting and secondly, the outer surfaces of these flanges are closely matched to the side walls of opening 23 in the fixed pinch grip jaw to maintain consistent alignment with the fixed jaw throughout the pinch grip range of motion.

The pivot post 18a and 18b and the sockets 19a and 19b define a pivot axis for the pinch grip with the pinch grip having a garment engaging means 16 mounted below the pivot axis. The user engagement portion 24 extends upwardly from the pivot axis to enable the user to open the pinch grip for insertion of the garment between the garment engagement pads 16. The user engagement portion 24 also enables the user to open the pinch grip for release of the garment in the pinch grip. The first fixed jaw also includes a forwardly extending flange or guard member 26 which is mounted on the forward face of the fixed pinch grip jaw 10b and extends forwardly pass the center line of the hanger support bar 105 to prevent the accidental dislodgement of garments from the pinch grip when two adjacent hangers are inadvertently pressed together.

The operation of the guard 26 can be better illustrated in a comparison of FIGS. 6a and 6b which are cross sections through one of the pinch grips with FIG. 6a illustrating the jaws as they would appear in a closed position. The pinch grip jaws are illustrated in an operation position suspending a garment in FIG. 6b. As illustrated in FIG. 16a, the fixed jaw 10b is mounted on an offset behind the rear plane of the hanger bar 105 and the guard member 26 extends forwardly or perpendicularly to the plane of support bar 105 to a distance sufficient to cover the user engagement portion 24 of the second moveable jaw when the clip is in use suspending a garment. As illustrated in FIG. 6a, when the clip is closed and not in use, the user engagement portion 24 extends beyond the guard 26. As will be hereinafter described in greater detail with respect to FIG. 7, this extension provides one point of a four-point engagement plane for stacking the hangers in a magazine. Magazine feed of the hangers enables the improved pinch grip hanger of the present invention to be used in an automated hanger dispensing apparatus. As illustrated in FIG. 6b, the pinch grip has engaged a garment between the fixed and moveable jaws, and the user engagement portion 24 is now protected by guard member 26.

As described above, protection of the user engagement portion 24 is necessary in a pinch grip hanger to prevent inadvertent actuation of the pinch grip when two or more of the improved pinch grip hangers are suspended from their respective hooks and placed adjacent one another. Without the guard, if the hangers are pressed together by shipping loads, or eager shoppers, the pinch grip will be opened, allowing the garment to fall. The present invention avoids this problem in two ways. In the first way, the fixed guard 26 of the first hanger will engage the rear plane 30 of the pinch grip to the second of two hangers when the hangers are pressed together thereby preventing engagement of the user engagement portion 24 and accidental opening of the pinch grip and release of the garments. As noted earlier such inadvertent opening can occur in a retail store environment as customers push the garments to one side to better view a garment of choice or can occur in the shipping environment when unexpected shipping loads occur on the container or truck in which the garments are being transferred. When such loads are encountered, adjacent hangers may impact one another and open one or more of the pinch grips if the pinch grips are not protected.

The pinch grip illustrated in FIG. 6a and 6b also has a second means for protecting against the inadvertent actuation of the pinch grip. The pinch grip is constructed with a pair of arches generally indicated at 32 and 34 in FIGS. 6a and 6b, which bow outwardly below the pivot axis defined by pivot post 18a and pivot socket 24a. When a garment is engaged and the pinch grip in use, as illustrated in FIG. 6b, the outward arch 34 of the second moveable pinch grip arm 12b extends outwardly beyond the user engagement portion 24 and will engage the arch 32 defined on the rear surface of the fixed pinch grip arm 10b when two adjacent garment hangers impact one another. However, since the impact occurs below the pivot axis defined by pivot post 18a and pivot socket 20a, any impact loading tends to close the pinch grip, rather than open it.

The plurality of hangers is illustrated in FIG. 4 and 5 illustrate the manner in which the guard members 26 and the arch members 34 prevent the inadvertent actuation of the pinch grip. As illustrated in FIG. 4, three hangers 100a, 100b and 100c are suspended from a common suspension point illustrated by axis S-S′. In FIG. 4 each of the pinch grip hangers is suspending an article of clothing that is clamped in its respective pinch grips. As illustrated in FIGS. 4 and 5, each of the hanger support bars 105a, 105b and 105c define a center axis illustrated with respect to hanger bar 105c as H-H′. This axis is perpendicular to the suspension axis S-S′ and may also be used to generate a vertical plane extending upwardly from the support bar 105 in a direction perpendicular to the plane of FIG. 4 and extending downwardly through the pinch grip 90a and 90b and parallel to the plane of the garment suspended by the hanger. FIGS. 4 and 5 illustrate an impacting engagement of the hangers wherein the rear surface 30 of each of the respective pinch grips provides an engagement point for the pinch grip guard 26. Thus, the user engagement portion 24 is protected from inadvertent actuation by guard member 26.

It should be noted that the offset placement of the pinch grips and the dimensioning of guard 26 and the user engagement portion 24 provide a hanger of reduced depth as will be hereinafter described. First as noted with respect to FIG. 6a and 6b, the overall depth of the hanger is that as illustrated D-D′. Thus when shipping empty garment hangers the depth of the hanger is substantially reduced from that of the prior art devices. For example, in the hanger of the present invention, the depth D-D′ is approximately ½ inch, while the depth of the prior art hangers is approximately ¾ inch. Thus each lineal foot of carton of new and unused empty hangers of applicants invention will contain 24 hangers, whereas the prior art will only stack 18 hangers in the same space. This significantly reduces the shipping cost for the hangers when shipping to garment manufacturers since garment hangers are typically shipped and billed in accordance with bulk in addition to weight.

As was described previously, and as can be seen in FIG. 6b, when a garment is engaged in the pinch grip of the hanger, the maximum depth of the hanger is from the outside of the arch 32 to the outside of the arch 34, is dependant upon the thickness of the folded material in the garment being shipped. The protective guard 26 begins to function when a ⅛ inch thick garment is being gripped by the pinch grip jaws 10b and 12b. At this level the distance between the outside of arch 32 and the outside of arch 34 is approximately ⅝ inch, still of reduced depth when compared to the prior art devices.

It should also be noted that the pinch grip of the present invention may also be opened to a wider dimension than the pinch grips of the prior art. For example, in the prior art hanger illustrated in U.S. Pat. No. 6,021,933, the plastic teeth utilized in this hanger begin to impede the insertion of any garment having a waistband thicker than ½ inch. When gripping a ½ inch thick object, the outside maximum dimension of the prior art pinch grip is approximately 1 inch. In contrast, and as illustrated in FIG. 6C, the pinch grip of the present invention can accommodate garments that are far thicker than ½ inch. Further, when engaging a ½ inch thick object, the maximum depth of the hanger is approximately ¾ inch. Thus a single lineal foot of shipping rod or display rod will support 16 hangers of the present invention having a garment with a ½ inch waistband gripped therein, while the prior art pinch grip hanger will only accommodate 12 hangers in the same space. This significantly increases the number of hangers in garments that may be shipped utilizing the pinch grips of the present invention.

As will be noted in FIG. 5, the hanger bar 105c illustrates in dotted hidden line illustration, the offset at 11b which mounts the fixed jaw 10b behind the rear plane of hanger bar 105c and behind the center axis H-H′ of the hanger. As will be noted, the pivot post 18a and 18b extend through the center axis H-H′, to provide a pivot axis forward of the center horizontal bar axis H-H′. The square M cross-section of center support bar 105 is carried or continued through the offset at 11b until merging with the fixed jaw as best illustrated in FIG. 3b.

As will be noted in FIG. 6c, the pinch grip of the present invention has an extraordinary opening for receiving material to be clamped. This opening is further enhanced in the elongated pinch grip hanger (not illustrated). Having a wide opening in the extreme open position facilitates insertion of clothing into the pinch grip when the pinch grip is used in an automatic dispensing machine that presents the hanger to the operator with the clips opened for insertion of a garment. The range of motion found in the improved pinch grip of the present invention is due to a combination of factors that are illustrated in FIG. 3b, 6a and 6c. The rear wall 30 of the fixed clip includes several molded components, including a relatively short and planar upper wall 30a and an inwardly sloping diagonal wall 30B having or defining an opening 23 as best illustrated in FIG. 3b. It should be noted that channel 15a and 15b extend upwardly and are resumed on the opposite side of the pivot posts 18a and 18b to further strengthen the upper portion of the fixed grip. The first fixed pinch grip jaw also includes the guard member 26 on one side, and an outer shroud portion 30d on the opposite side, all of which components together contribute to strengthen the configuration of the fixed grip. As was noted earlier, when the moveable pinch grip jaw is actuated to its fully extended position as illustrated 6c the guide members 22a and 22b extend through the opening 23 defined in rear wall 30b to further assist in the prevention of any twisting or lateral motion of the pinch grip. The angle of wall 30b is essentially parallel to the angle of the moveable pinch grip jaw but offset therefrom by the depth of the arch at 34. The offset and the opening of the jaw is also determined by the length of the pivot post 18a and 18b which extend outwardly from the rear wall of the fixed clip past the center line axis of the center support bar 105. The pivot posts define a pivot axis for the moveable pinch grip jaw on the user side of the hanger center line H-H′. This combination of factors results in an advantageous and extremely wide opening of the pinch grip jaws as illustrated in FIGS. 6c, which assists the operator in inserting garments into the pinch grip.

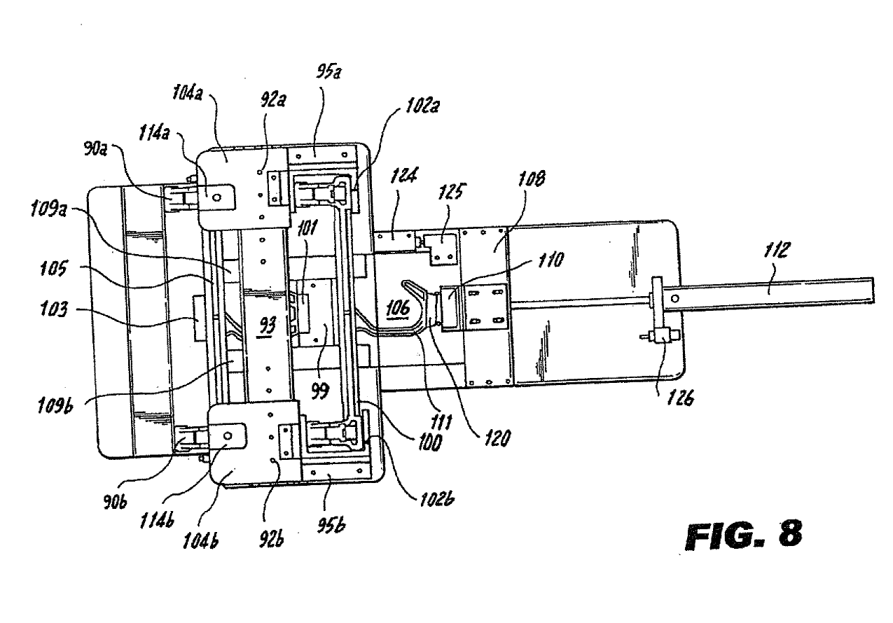

The present invention also includes a multi-stage spring 15 which will now be described with respect to FIGS. 6a-6c and 10a-10b. Spring 14 uses a combination of linear elements and a moving arched fulcrum to provide a relatively constant bias throughout the useful operating range of motion. It is noted that in the design of various spring members, each spring has a defined spring constant, and the force required to deflect the spring will vary according to the deflection of the spring and the length of the spring over which the force is applied. In the prior art pinch grip hangers, the further the moveable jaws are opened, the more difficult it is to overcome the bias exerted by the spring. The present invention uses the linear portions to be described and a moving fulcrum or spring engagement point to offset the increased bias resulting from increased deflection of the spring member. As illustrated in FIGS. 10a and 10b, the spring is a steel member and in a preferred embodiment was formed of steel A.S.S C1050 heat treated to 42-49 Rc. The spring member was approximately 0.325 in width and 0.024 inches in thickness. The overall height of the spring was 1.134 inches and the width, when bent to the configuration as illustrated in Figure 10a was 0.454 inches. The spring member 14 includes safety lock means formed by hook members 14c and 14d which define a nearly 180 degree return of the spring, and which engage internal retention ribs formed in the outer sides of the fixed and moveable jaw members of the pinch grip.

These safety locks serve two purposes. First, with the prior art hangers, it is possible to inadvertently dislocate or remove the moveable jaw, by pulling downwardly on the jaw. This can happen inadvertently by stress loading the garment in the grip in the downward direction, particularly if the moveable jaw has a stronger grip on the garment than the fixed jaw. This downward force may be exerted by the garment in response to a sudden change in direction of the container or truck in which the garment is being transported, or by a customer or sales person trying to pull the garment out of the pinch grip before the grip is fully open. This downward force is particularly noticeable where the elongated pinch grip hanger contains a garment having a distinct waistband, and a customer pulls downward so as to jam the waistband against the teeth 16c, 16d of the pinch grip jaw. Secondly, once the jaw of the prior art devices are dislocated, it is possible for the spring to fly off the pinch grip, and if this happens in a retail environment it may strike a customer or sales person. The returns, or hooks 14c, 14d enable the spring to be locked into the pinch grips via the rib configuration molded into the pinch grip jaws, as illustrated in FIGS. 6(a)-6(c). If a downward force is exerted on the moveable jaw, the retention rib 12c is caught by the hook 14d, locking the moveable jaw to the hanger. Downward force on the spring is resisted by the engagement of the spring at 14e-14f against the fixed pinch grip jaw 10b, and stopped entirely by the hook 14c as it engages retention rib 10c. As noted in FIGS. 6a-6c and FIGS. 10a-10b, the spring includes three linear portions on each side joined at the bight 14k with a radius of constant curvature of approximately R0.094.

When the spring is installed as illustrated in FIG. 6a, and 6d-6f, it may be snug fitted or may be fitted or may be fitted so that it does not engage either the fixed jaw or the moveable jaw except at hook members 14c and 14d and the immediate adjacent linear portions 14c- 1 4e and 14d-14h. The upper bight portion 14k extends through the opening 23 and over protrusion 18c through opening 21 in the moveable jaw to its mounting point as illustrated in FIG. 6a, and 6d-6f. When free mounted, as illustrated as FIG. 6a, and 6d-6f, the bight portion 14k may be shifted laterally in the direction of arrows B-B′ a millimeter or two in either direction. Thus the initial opening of the spring begins with the longest possible throw or leverage on bight member 14k extending from 14e to 14h. However, shortly after opening, the moveable pinch grip jaw 12b pulls the spring forward in the direction of arrow C in FIG. 6b causing spring member 14 to engage the arched member 32 formed in the fixed jaw extending from 14e to 14f. Thus for the second stage of spring opening, the effective fulcrum of the spring runs from 14f through the bight 14k to a position between junctions 14g and 14h. The engagement between 14g and 14h along the arch member 12c is progressive, providing a moving fulcrum or anchor for the spring 14. As the pinch grip moves from the position illustrated in FIG. 6b to the position in FIG. 6c, the spring is progressively opened and the arch 34 is rolled away from spring 14 causing the operative portion of the spring to be progressively lengthened from 14g to 14h as the jaw is opened. When finally opened to the jaw opening illustrated in FIG. 6c, the spring is only making contact between 14h and 14b on the moveable jaw side. As noted above, contact is maintained at 14f against the rear wall of the fixed clip. Thus, the spring 14 may be held in the open position with the maximum leverage on the spring bight 14k. In the multi-stage spring of the present invention, the increase in stiffness due to increasing deflection of the spring is offset by a progressively longer mounting point for the spring, so that the user feels an apparent constant spring bias throughout the range of motion.

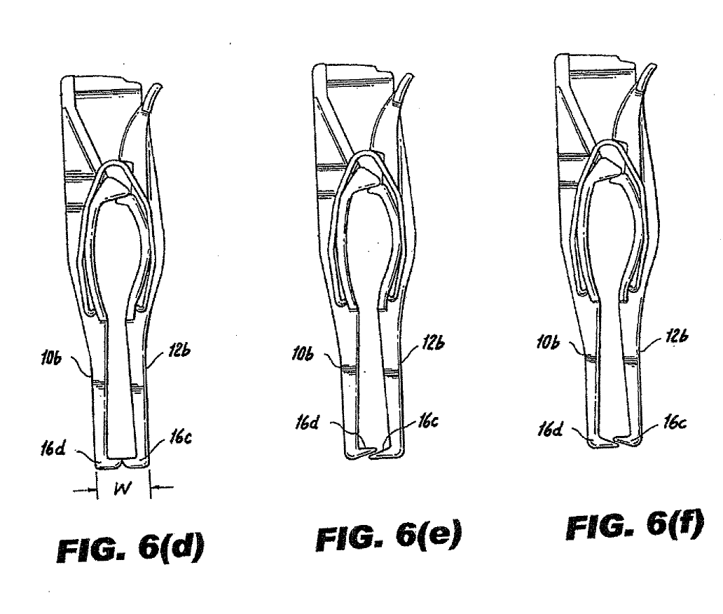

FIGS. 8 & 9 illustrate a Pinch Grip Hanger Loading Mechanism particularly adapted to dispense the improved pinch grip hangers of the present invention. This mechanism is more fully described in U.S. Ser. No. 10/076,790, filed on Feb. 15, 2002, and assigned to the assignee of the present invention. The specification of this application is incorporated herein in its entirety, by reference thereto. Specifically, the mechanism promotes the safe and efficient operation of placing garments on pinch grip hangers for subsequent shipment and display.

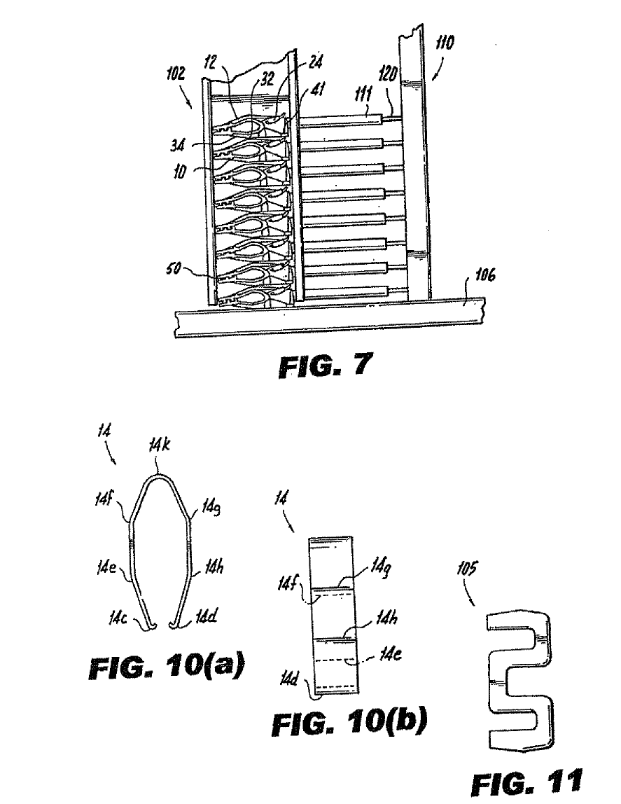

As illustrated in FIGS. 8 & 9, a hanger magazine 102 is provided for vertically storing and loading a plurality of hangers 100 for the mechanism. The hangers are placed in the magazine 102 either singularly or as an attached group of hangers held together by a clip (not illustrated). The magazine includes a pair of upwardly extending receptacles 102a, 102b that are spaced above a main base 94, as best illustrated in FIG. 9 when hangers are loaded into the magazine, each hanger is oriented flat to the horizontal main base 94 with the clip portion of the hanger having its opening side facing the operator.

The magazines 102a, 102b are adjustably suspended above main base 94, and attached to intermediate base members 104a, 104b by means of brackets 95a, 95b. Pinch grip ram cylinders 114a, 114b are used to open the hanger pinch grips, and are also attached to base members 104a, 104b. Intermediate base members 104 are supported above main base 94 by means of inverted unshaped support bracket 93. The brackets 95a, 95b suspend the magazines 102a, 102b from the base members 104a, 104b, so that the lower portions of magazines 102a, 102b are elevated a defined distance above main base 94, as will be hereinafter discussed in detail. The main base 94 is supported by legs 98a, 98b and 96, which together provide a stable platform for the device and allow the device to be located at an elevation and location convenient to the operator.

The distance between base members 104a and 104b can be laterally adjusted on support 93 to allow various sizes of hangers 100 to be used in the mechanism. The base members 104 are adjusted by means of adjustment holes, two of which are identified at 92a, 92b. This enables magazines 102a, 102b and ram cylinders 114a, 114b to be moved into proper positions on either side of a centerline axis of the mechanism for use of the mechanism with various hanger lengths or sizes. In a preferred embodiment of the mechanism, the centerline axis is defined by the reciprocal movement of the push plate 106.

The push plate 106 is designed so that other hangers in the magazine 102 are retained in the magazine, and do not snag on the push plate 106 or otherwise leave the magazine when the push plate is in motion. The feed mechanism is a “slice feeder” in which the push plate 106 reciprocates back and forth under the magazine 102 and appears to be slicing off a single hanger 100 with each reciprocation. The dimensions and position of the push plate 106 with respect to the magazine 102 may be adjusted so that the device can accommodate a variety of hanger thickness, or alternately the device may utilize matched sets of magazines and plates, with each set appropriate for a specific hanger design. In operation, the next hanger in the magazine 102 is only released from the magazine 102 when the push plate has fully reciprocated to its rearward position. As the push plate 106 is retracted under the magazines 102, a single hanger 100 is released from the magazine and drops onto main base 94. The bottoms of magazines 102 are adjusted to be approximately one hanger thickness above the main base 94. As the push plate begins its cycle of operation, the push plate 106 reciprocates forwardly to engage the hanger 100 on main base 94. As illustrated in FIG. 8, the hook of the hanger is not initially engaged, as it falls into a cut out portion in the push plate 106 that extends between two hanger engaging arms 109a and 109b. As the push plate 106 advances, the engaging arms 109a, 109b engage the horizontal support bar 105 of the hanger 100, and begin to advance the hanger towards the operator. Only a single hanger is advanced at a time, since the dimensions of the slot below the magazine and the push plate 106 are too close to allow a subsequent hanger to be released.

During the slice feeding, the push plate 106 moves forward and then backwards under the next to be dispensed hanger, with the push plate sliding under the next to be released hanger, which is constrained from movement by magazine 102. The sliding surface of push plate 106 prevents the hanger above the push plate 106 from dropping to the main base 94 until the push plate 106 is fully retracted. At that time, the next to be dispensed hanger is exposed to the main base 94, which allows the stack of hangers to drop downwardly so that the next hanger to be dispensed rests on the main base 94. This hanger is then advanced with the next reciprocation. The thickness of the hanger and the dimensions of the dispensing slot and the thickness of the push plate 106 prevent multiple hangers in the magazine from being dispensed or causing the device to jam on a second hanger.

The present invention is intended to work with either wire hook hangers or plastic hook hangers, and the forgoing description is equally applicable to both types of hangers. Optionally, when plastic hook hangers are used, it may be desirable to automatically affix a size cap to the hanger at the time the hanger is positioned for garment loading. The following description is relevant to this option.

When desired, the present invention enables the size caps to be automatically attached to the hook portion 111 of the hanger 100. As illustrated in FIGS. 8 and 9, a size cap magazine 110 may be located between the hanger magazines 102a, 102b and the push plate reciprocating cylinder 112. The mechanism works in concert with the reciprocating action of the push plate 106. Again using a slice feeding technique, a portion of the push plate 106 is designed to remove a single size cap 101 from the size cap magazine 110 each time the device moves towards the operator, and the size cap is then affixed to the hanger as the hanger advances towards the operator. As described previously with respect to the hangers, subsequent size caps in the magazine are prevented from release from the size cap magazine 110 by the dimensions of the opening below the magazine, the thickness of the size cap and the thickness of the push plate 106 immediately following the receptacle or cut out for the size cap. The leading edges of the push plate arms 109a, 109b may be supplied with compressible resilient engaging means at the point of engagement with the hanger support bar 105. This resilient mounting allows the size cap to be forced onto the flange 120 of hanger hook 111 of the hanger 100, without placing extraordinary stress on the hanger hook 111, the flange 120 of hanger hook 111, or the hanger 100.

The following is an example of the operation of the present invention utilizing size caps 101 that are mounted on a hanger hook 111. Typically the hanger hook flange 120 and the size cap 101 have engagement formations which require a certain amount of force to overcome the resistance, but upon application of such force in the engagement of the two pieces, the hanger 100 and size cap 101 snap fit to one another. The snap fit may be permanent, as taught by U.S. Pat. No. 5,604,975, or releasable, as taught by U.S. Pat. No. 5,794,363. As noted above, both of these patents are assigned to the assignee of the present invention, and the disclosures of both patents are incorporated herein by reference thereto. As the push plate 106 begins its first reciprocal movement towards the operator, a size cap 101 is removed from the size cap magazine 110. The removed size cap is captured within a cut out or a receptacle 178 (illustrated in FIG. 8) mounted on the push plate 106 and fed to the flange portion 120 of the hook 111 to which it will be attached. Before the engagement arms 109a, 109b engage the hanger support bar 105, the size cap is advanced over the hanger flange 120, and by the time the engagement arms 109a. 109b engage the hanger, the flange 120 is positioned within an internal recess in the size cap 101. The hanger and size cap assembly, with the cap loosely applied to the flange 120 of the hanger 100, are moved towards a hanger stop position at hanger stop 103. Upon reaching the hanger stop 103, the hanger 100 and hanger bar 105 are stopped. However, the push plate 106 continues to move towards the operator a short distance. This distance enables compression of the resilient engagement tips at 109a, 109b which allows the push plate 106 to force the snap fit engagement of size cap 101 to flange 120 of hanger hook 111. Due to the compressive force imparted on the size cap by the push plate 106 as it moves through the resilient mounting at 109a, 109b, the size cap is firmly seated on hanger flange 120 in a snap fit engagement with the hanger. The resilient mounting of the push plate 106 insures that the force imparted upon the hanger 100 is not so great to damage the hanger hook 111 or the hanger support bar 105. Alternately the same effect may be accomplished by resiliently mounting a size cap receptacle to push plate 106. The resilient engagement allows a small amount of over travel which forces the size cap onto the hook without damaging the hook

The push plate 106 is advanced and retracted by a reciprocating cylinder 112. In the example shown in FIGS. 1-5, the reciprocating cylinder 112 is a double acting pneumatic cylinder, however, it is understood that the reciprocating cylinder could be of a variety of other designs. The reciprocal movement of the push plate 106 defines a centerline axis for the mechanism.

As the push plate 106 is advanced towards the operator, and after the push plate has engaged the size cap and hanger 100, and positioned the hanger at the hanger load position, a control engagement cam 125 engages an pneumatic switch 124, which initiates a pneumatic signal which is sent through the pneumatic control system to actuate a pair of pinch grip cylinder rams 114a, 114b. The stroke of cylinder 112 limits the travel of the push plate 106 so that there is no further movement of the push plate after reaching a stop position and hanger stop 103. When the hanger reaches the stop position, each of the pinch grip cylinders 114a, 114b project rams 122 onto their respective pinch grips of the hanger 100, as illustrated in FIG. 9 opening the pinch grips 90a, 90b and overcoming the opposition of the pinch grips spring which keeps the pinch grip in a normally closed position.

With the pinch grips 90a, 90b open and the hanger secured in the stop position, the operator can insert a garment into the now open pinch grips. As illustrated in FIG. 9 proximately located to the open pinch grips, and preferably external to the rams 122 and pinch grips 90a, 90b are triggering devices 116. The triggering devices 116a, 116b are actuated by the outer edges of the garment when the operator places the garment in the pinch grip clips 90a, 90b. The operator picks up a garment to be hung from the hanger 110, typically a pair of slacks or a skirt, and pulls the waistband taut between her hands. The taut waistband is then inserted into the pinch grips 101 with both hands on the outside of the device, whereby the triggers 116 are actuated by the portions of the garment that extends beyond the outer edges of the hanger. The device also employs a sloping garment guide 94a which joins main base 94 to assist the operator and guide the garment waist band into pinch grips 90a, 90b.

The placement of the triggers 116 to each side of the location where the garments are inserted provides an added safety feature for the device. Since there is no opportunity for an operator to inadvertently injure herself while operating the device. This is a result of the dual trigger mechanism, which necessitates that the operator grip the garment at its outer edges, and pull it taut for insertion. The operator must pull the garment outward at its ends with both hands to insure that there is no sagging of the garment between the grips. Thus, both of the triggers are tripped while the garment is in the proximate location after it is inserted into the pinch grips. As a result of requiring the operator to use both hands to hold the garment to trip the triggers, there is a reduced likelihood that the operator can inadvertently injure himself or herself. This increased safety is due largely to the fact that their hands are holding the ends of the garment, and therefore cannot inadvertently engage any of the reciprocating elements of the device.

Upon triggering, two actions take place. Instantly, the pinch grip cylinder rams 122(a) and 122(b) are retracted. The retraction allows the spring force of each pinch grip 90 to return to its normally closed position, thereby securely gripping the garment there between. This permits the operator to lift the hanger and garment combination off of the main base 94, and place the combination elsewhere for further processing. Secondly, the push plate 106 begins moving in a direction away from operator. As the push plate 106 passes the magazine 102, a new hanger 100 drops to the main base 94 and the process begins a new.

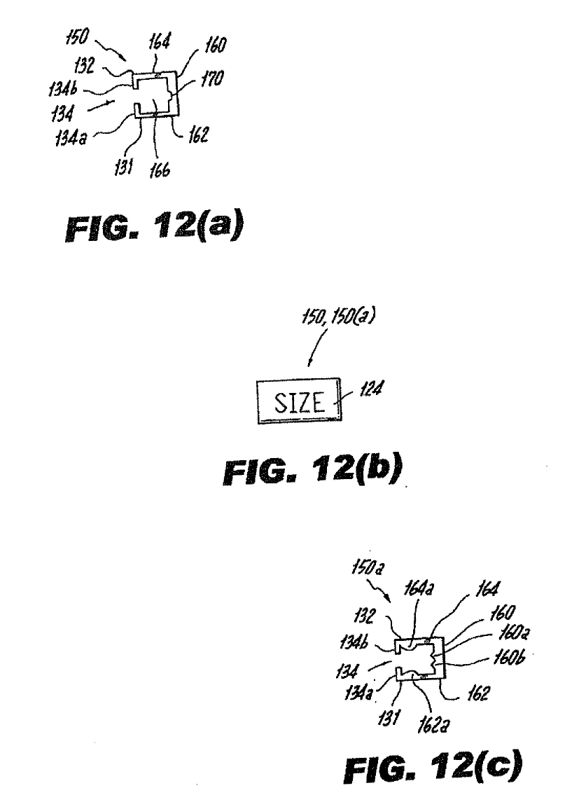

FIG. 7 is an enlargement of a portion of FIG. 9 which illustrates a stack of the improved pinch grip hangers of the present invention loaded in magazine 102 with the reciprocating push plate 106 positioned immediately there below. Each of the hangers is dimensioned such that the outer portion of the arch 40 on each of the moveable jaws 12 is essentially parallel to the tip 41 of the user engagement portion 24. This enables the tip 41 of the user engagement portion 24 to rest against the flat surface defined by rear wall 30A illustrated in FIGS. 6A-6C. The forward of portion of arch 34 engages the rear arch 32 formed on the fixed jaw 10 as previously described. As noted previously, the rear wall of the fixed jaw is offset from the rear wall of the hanger body 105 and accordingly hook member 111. Inasmuch as each hanger has a pair of pinch grip, and there are two points of engagement on each pinch grip, the present invention this provides a stable 4 point mounting of the pinch grip hangers when they are stacked on one another and loaded into a magazine such as magazine 102 illustrated in FIG. 7. This facilitates the automatic dispensing of the hangers from magazine 102 by push plate 106. As described above, and if desired, size caps may be loaded in magazine 110, and a size cap will be affixed to the hanger as it is dispensed by the push plate 106. Referring again to FIG. 2, the garment hanger of the present invention is generally referred to by reference numeral 100. The hanger body or horizontal support bar 105 has at least one flange or web 120a for removably securing a side size indicator (FIG. 12a-12c) to the web 120a molded onto support bar 105. As illustrated in FIG. 2, the web 120a is located at a junction between the hook 111a and the body 105. The flange or web 120a may be also be molded adjacent an all plastic hook and hanger, such as the hanger illustrated in FIG. 1.

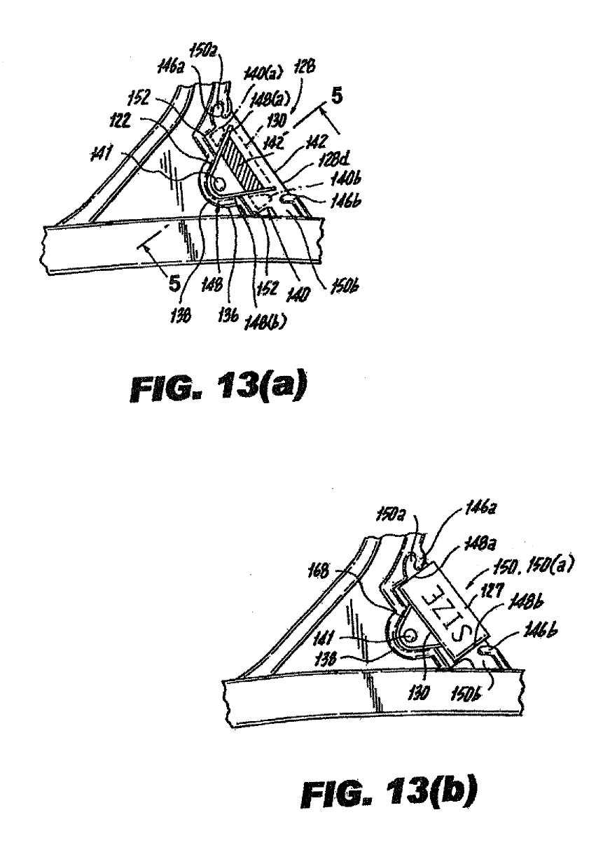

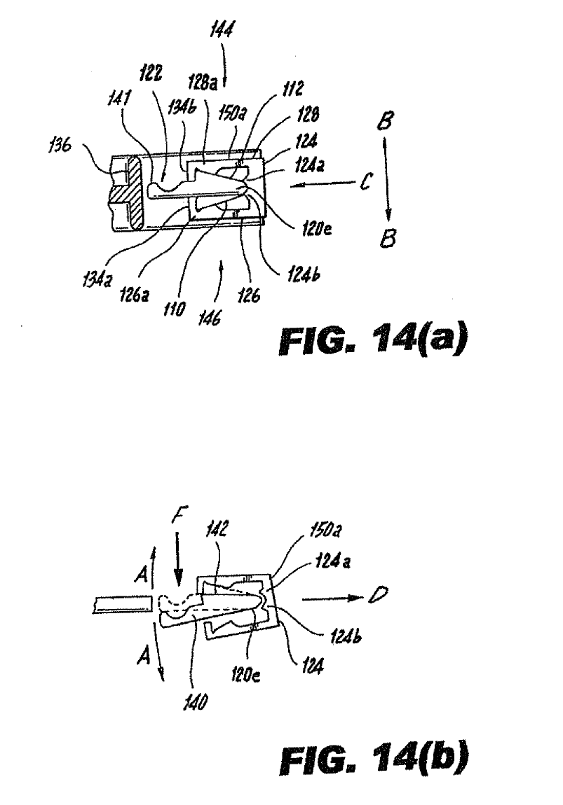

Referring Now to FIG. 13a, the web has a fixed latch 140 and a pivoting latch 142. The pivoting latch 142 is preferably located at a central portion of the web 120a and the fixed latch 140 is located on at least one end of the pivoting latch 142. Preferably, the fixed latch 140, as shown in FIG. 3, comprises two abutments 140a, 140b located on each end of the pivoting latch 142. As illustrated in FIGS. 14a and 14b, it is also preferable that the pivoting latch 142 projects from a first side 144 of the web 120a and the fixed latch 140 projects from an opposite side 146 of the web 120a.

Referring back to FIG. 13a, the pivoting latch 142 is preferably defined by a slot 148 cut through the web 120a. The slot preferably has a shape defined by at least two sides 148a, 148b. The pivoting latch 142 is further defined by a living hinge, shown by dotted line 120c closing the shape of the slot 148. As shown in FIG. 13a, the slot 148 is preferably substantially two sided 148a, 148b and the living hinge 120c closes the shape of the slot 148 thereby forming a triangular shaped pivoting latch 142.

Referring now to FIGS. 13a, 13b, and 14a in combination, the pivoting latch 142 preferably has an engagement means for facilitating movement of the pivoting latch about arrow A shown in FIGS. 14b. The engagement means preferably comprises a cantilevered end 122 of the pivoting latch 142 which when a releasing force (F) is applied thereto provides a mechanical advantage for movement of the pivoting latch 142 out of engagement with the size indicator. Simultaneously, the opposite side of the pivoting latch 142 displaces the size indicator such that it no longer engages the fixed latch 140.

Referring now to FIGS. 12a, 12b, and 14a in combination, two versions of the size indicator are illustrated as 150 and 150a, with size indicator 150 generally having a face 124 and two sides 126, 128 depending therefrom to form a generally C-shaped channel 129. Each of the sides 126, 128 terminate in a foremost edge 130, 132. The foremost edges 130, 132 are preferably configured such that the cantilevered end 122 of the pivoting latch 112 is exposed when a size indicator 150 is secured on the web 120a.

The size indicator 150 includes finger means 134 for engaging the fixed and pivoting latches 140, 142, respectively, such that the size indicator is secured on the web during normal use. However, the size indicator is releasably secured on the web 120 such that it may be released from the web 120a when the pivoting latch 142 is pivoted out of engagement with the finger means 134 of the size indicator when the release force (F) is applied. The finger means 134 preferably comprises an inwardly facing ridge 134a, 134b disposed at each of the foremost edges 130, 132 and projecting inwards towards the channel 129 of the size indicator 150.

In an alternative version, a second size indicator 150a of the first embodiment is illustrated in FIG. 12c in which like reference numerals refer to similar features, the second size indicator being referred to generally by reference numeral 150a. The second size indicator 150a has engagement abutments 126a and 128a which protrude from the inside of the sides 126, 128, respectively, to touch the side walls of the fixed and pivoting latches 140, 142 when secured to the web 106a. As will be discussed below, the size indicator 150a further has a pair of spaced projections 124a, 124b projecting from an inner surface of the face 124.

Referring back to FIGS. 13a and 14a in combination, the web preferably also has a guard 136 extending across the web 120a and below the size indicator 150a. In a preferred implementation, the guard 136 has a down-turned portion 138 which follows the contours of the cantilevered end 122 to thereby enable access to the edges of the size indicator and the engagement means 122 but prevents inadvertent actuation of the pivoting latch 142. The cantilevered end and engagement means 142 are preferably configured to engage a tool (not shown) used for application of the releasing force (F). The engagement means is preferably a dimple 141 formed on a side of the cantilevered end 122. The tool having a tip substantially conforming to the shape of the dimple 141 and having a width such that it is not prevented from engaging the dimple 141 by the guard

The web preferably also has an outermost edge 120d having an outermost portion 120e of a predetermined cross-section. The first version of the size indicator 150 has a trough 124c (FIG. 12a) with a mating cross-section substantially configured to receive the outermost portion 120d therein for preventing a lateral movement of the size indicator along direction B-B (FIG. 14a) when the size indicator 150 is secured on the web 120a. The preferable predetermined cross-section of both the outermost portion 120e and the trough 144 is substantially rectangular. The second version of the size indicator 150a having first and second spaced projections 124a and 124b, respectively, which project from the inner surface of the face 124. The first and second projections 124a, 124b are spaced such that the outermost portion 120e is accepted therein when the size indicator 150a is secured on the web 106a to prevent lateral movement of the size indicator 150a along direction B-B (illustrated in FIG. 14a).

The engagement abutments 126a, 128a cooperate with the trough 144 or the first and second spaced projections 124a, 124b to prevent side to side movement of the size indicator on the web and contribute to a secure and solid attachment of the size indicator tot he hanger.

Referring to FIG. 13b, the web 120a further comprises locating means for locating the size indicators 150, 150a in a predetermined position on the web 120a. The locating means preferably comprises first and second guides 146a, 146b disposed adjacent each side edge 148a, 148b of the size indicator 150, 150a and spaced apart to align the size indicators therebetween and to center the size indicators during application thereof on the web 120a. Preferably, the first and second guides 146a, 146b do not extend the fall length of the side edges 148a, 148b of the size indicator but define elongate openings 150a, 150b which expose the side edges 148a, 148b of the size indicator.

Referring now to FIGS. 14a and 14a, the operation of the garment hanger 100a of the present invention will be explained with regard to size indicator 150a. Size indicator 150a is mounted on the web 120a by sliding it over web 120a in the direction of arrow C. While being mounted in the direction of arrow C, the pivoting latch 142 pivots in the direction of arrow A until the inwardly facing ridges 134a, 134b of finger means 134 pass over the fixed and pivoting ridges 140, 142. After which, the inwardly facing fingers 134a, 134b snap into place in an area defined by the guide 136 and a bottom edge of the fixed and pivoting ridges 140, 142. As such, the size indicator 150a is releasably secured on the web 120a.

To release the size indicators 150, 150a from the web 120a, a releasing force (F) is applied to the cantilevered end 122 of the pivoting latch 142, preferably by engaging the dimple 141 thereon with a release tool (not shown). The release force (F) results in the pivoting latch 142 to pivot about the living hinge 120c in the direction of arrow A. As can be seen in FIGS. 14a and 14b, planar side wall of the pivoting latch 142 causes the inner ridge 134a of the finger means 134 of size indicators 150, 150a to extend past the furthest extending portion of the fixed latch 140. At this point, the size indicator 150, 150a may be manually removed from the web 120a.

While several embodiments and variations of the present invention for a pinch grip hanger mechanism are described in detail herein, it should be apparent that the disclosure and teachings of the present invention will suggest many alternative designs to those skilled in the art.

What is claimed is:

1. An improved pinch grip hanger, said hanger comprising;
a hook and a support bar suspended from said hook,
at least one pinch grip mounted on said support bar along the length thereof, said pinch grip having first and second pinch jaws, with the first jaw mounted on said support bar in a fixed location, and the second jaw pivotally mounted with respect to said first jaw, said second jaw having a user engagement portion, and a garment engaging portion extending downwardly from said support bar, said user engagement portion enabling a user to open the pinch grip for insertion or release of a garment in said pinch grip;
a multi-stage spring mounted on said first and second pinch grip jaws biasing the garment engaging portion of said second jaw into engagement with said first jaw, said multi-stage spring having a fulcrum substantially centered between a first and a second spring side, with each of the first and second spring sides comprising a plurality of linear portions, said biasing thereby enabling said pinch grip to clamp and suspend a garment between said first and second pinch grip jaws.

2. The pinch grip hanger according to claim 1, said multi-stage spring further comprising plural stages of spring engagement thereby maintaining a substantially constant spring bias throughout the range of motion of said pinch grip.

3. The pinch grip hanger according to claim 1, wherein said multi-stage spring engages both said first jaw and said second jaw.

4. The pinch grip hanger according to claim 1, said multi-stage spring further comprising a safety lock means to maintain spring engagement with said jaws.

5. The pinch grip hanger according to claim 4, wherein said safety lock means comprises a hook member on at least one end of the multi-stage spring.

6. The pinch grip hanger according to claim 1, said multi-stage spring further comprising a hook member on at least one end of the multi-stage spring to maintain spring engagement with said jaws.

7. The pinch grip hanger according to claim 6, wherein said hook member defines an up to 180 degree return of the spring.

8. The pinch grip hanger according to claim 1, further comprising a retention rib on one of the first and second pinch grip jaws for engaging and retaining the multi-stage spring.

9. The pinch grip hanger according to claim 1, one or both of said first and second jaws further comprising a recess therein, the recess engaging the multi-stage spring between an end of the multi-stage spring and a bight portion of the multi-stage spring when the second jaw is pivoted relative to the first, thereby effectively shortening the throw of the multi-stage spring.

10. The pinch grip hanger according to claim 1, wherein the at least one pinch grip is located at a first end of the support bar.

11. The pinch grip hanger according to claim 1, wherein said user engagement portion extends upwardly from a pivot axis of said second jaw.

12. The pinch grip hanger according to claim 11, wherein said garment engaging portion extends downwardly from said pivot axis.

13. The pinch grip hanger according to claim 12 wherein the fulcrum defines a central arcuate bight portion joining at least two of said linear portions.

14. The pinch grip hanger according to claim 13, wherein said multi-stage spring is substantially symmetric about a plane extending through the center of the fulcrum.

15. The pinch grip hanger according to claim 1, wherein said first and second spring sides each comprise at least three linear portions.

16. The pinch grip hanger according to claim 15, wherein at least one of the linear portions of each of the first and second spring sides are positioned at opposite sides of the multi-stage spring and are generally parallel with one another when the spring is at rest.

17. The pinch grip hanger according to claim 13, wherein said multi-stage spring comprises A.S.S C1050 steel heat treated to a hardness of between about 42-49 Rc.

18. An improved pinch grip hanger, said hanger comprising;
a hook and a support bar suspended from said hook,
at least one pinch grip mounted on said support bar along the length thereof, said pinch grip having first and second pinch jaws, with the first jaw mounted on said support bar in a fixed location, and the second jaw pivotally mounted with respect to said first jaw, said second jaw having a user engagement portion, and garment engaging portion extending downwardly from said support bar, said user engagement portion enabling a user to open the pinch grip for insertion or release of a garment in said pinch grip;
a spring mounted on said first and second pinch grip jaws biasing the garment engaging portion of said second jaw into engagement with said first jaw, said spring having a safety lock means to maintain spring engagement with said jaws, said biasing thereby enabling said pinch grip to clamp and suspend a garment between said first and second pinch grip jaws.

19. The pinch grip hanger according to claim 18, wherein said safety lock means comprises a hook member on at least one end of the spring.

20. The pinch grip hanger according to claim 18, further comprising a retention rib on one of the first and second pinch grip jaws for engaging the safety lock means and retaining the spring.

21. A multi-stage spring for biasing the pinch grip jaws of a pinch grip hanger into engagement with one another thereby enabling the pinch grip to clamp and suspend a garment between the jaws, the multi-stage spring comprising:
an arched fulcrum
a plurality of linear portions joined either to each other or to the arched fulcrum; and
at least one safety lock means at an end of one linear portion.

22. The multi-stage spring according to claim 21, wherein the at least one safety lock means comprises a pair of safety lock means, one each located on opposite ends of the multi-stage spring.

23. The multi-stage spring according to claim 21, wherein the safety lock means comprises a hook return.

24. The multi-stage spring according to claim 23, wherein the hook return comprises nearly 180 degrees of bend.

25. The multi-stage spring according to claim 21, further comprising a heat-treated steel material.

26. The multi-stage spring according to claim 21, wherein the plurality of linear portions comprises six linear portions, three on each side of the arched fulcrum.

27. The multi-stage spring according to claim 21, wherein the arched fulcrum has a constant radius of curvature.

28. A spring for biasing the opposing jaws of a pinch grip on a garment hanger into a closed arrangement, while permitting the opening of the pinch grip jaws upon application of an effective opening force, the spring comprising:
a first spring side comprising a plurality of linear spring segments, which spring segments are joined to each other;
a second spring side comprising a plurality of linear spring segments, which spring segments are joined to each other,
an arcuate junction joined to and positioned between the first and second spring sides;
wherein at least one of the first spring side and second spring side are in a bow-shaped configuration.

29. The spring of claim 28 wherein the first spring side and second spring sides are in a bow-shaped configuration.

30. The spring of claim 29 wherein the arcuate junction ha a substantially constant radius of curvature.

31. The spring of claim 29 wherein the location of joinder of adjacent segments of the first spring side and adjacent segments of the second spring side define an obtuse angle on an interior side of the spring.

32. The spring of claim 29 wherein the first and second spring sides are provided with means for maintaining spring engagement with the jaws of the hanger.

33. The spring of claim 29 wherein at least one of the first and second spring sides is provided with a hook in a jaw-engaging configuration at a spring side terminal end.

34. The spring of claim 29 wherein the first and second spring sides are each comprised of three linear segments.

35. A spring for biasing the opposing jaws of a pinch grip provided on a garment hanger into a closed arrangement, while permitting the opening of the pinch grip upon application of an effective opening force, the spring comprising:
a first spring side comprising a plurality of linear spring elements, which spring elements are joined to each other;
a second spring side comprising a plurality of linear spring segments, which spring segments are joined to each other;
an arcuate junction joined to and positioned between the first and second spring sides;
wherein at least one of the first spring side and second spring sides are in a truncated triangle-shaped configuration.

36. A spring for biasing into a closed arrangement the opposing jaws of a pinch grip provided on a garment hanger, while permitting the opening of the clip upon application of an effective opening force, the spring comprising:
an arcuate bight portion joined at first and second bight portion ends to first and second spring sides, respectively;
a plurality of linear spring segments comprising each of the first and second spring sides, wherein adjacent spring segments are joined together at vertices defining an obtuse angle on an inner spring side;
wherein when the spring is positioned on the pinch grip jaws of a pinch grip hanger predetermined arrangement and configuration of the arcuate bight portion, the linear segments of the first and second spring sides cooperate to exert a substantially constant spring bias through the range of motion that occurs in opening the pinch gap jaws

37. A spring for biasing into a closed arrangement the opposing jaws of a pinch grip on a garment hanger, while permitting the opening of the grip upon application of an effective opening force, the spring comprising:
an arcuate bight portion joined at first and second bight portion ends to first and second spring sides, respectively;
a plurality of linear spring segments comprising each of the first and second spring sides, wherein adjacent spring segments are joined together at vertices; and
wherein the first and second sides are provide with hook members at terminal ends of the first and second spring sides.

38. The spring of claim 37 wherein the first and second sides are symmetrically arranged about the arcuate bight portion when the spring is at rest.

39. The spring of claim 37 wherein the hook members define a 180 degree return.

40. A spring for biasing into a closed arrangement the opposing jaws of a pinch grip provided on a garment hanger, while permitting the opening of the clip upon application of an effective opening force, the spring comprising:
an arcuate bight portion joined at first and second bight portion ends to first and second spring sides, respectively;
wherein each of the first and second spring sides comprise a plurality of linear spring segments that include an upper spring segment extending in an outward direction relative to the bight portion, and a terminal spring segment extending in an inward direction relative to the bight portion; and
wherein when the spring is positioned on the pinch grip jaws of a pinch grip hanger, the predetermined dimensions and configurations of the arcuate bight portion and the linear segments of the first and second spring sides cooperate to exert a substantially constant spring bias through range of motion that occurs upon opening the pinch gap jaws.

41. The spring of claim 40 further comprised of a hook member positioned on an end of the terminal spring segment.

42. The spring of claim 41 wherein the hook members define a 180 degree return.
